(19) United States
(12) Patent Application Publication
(10) Pub. No.: US 2026/0039006 A1
(43) Pub. Date: Feb. 5, 2026

(54) ANTENNA SUPPORT STRUCTURE AND SYSTEM

(71) Applicants: 2J ANTENNAS USA, CORPORATION, Gilbert, AZ (US); 2J ANTENNAS, S.R.O, Bardejov (SK); 2J ANTENNAS UK, LTD, Waterlooville Hampshire (GB)

(72) Inventor: Michal Kosterec

(73) Assignee: 2J ANTENNAS USA, CORPORATION, Gilbert, AZ (US)

(21) Appl. No.: 18/550,516

(22) PCT Filed: Apr. 27, 2023
(86) PCT No.: PCT/US2023/020256

§ 371 Date: Sep. 14, 2023

(51) Int. Cl. H01Q 1/12; H01Q 11/08

(52) U.S. Cl. CPC H01Q 1/12; H01Q 11/08

(57) ABSTRACT

An antenna support structure is disclosed. The antenna support structure includes a first planar member and a second planar member wherein the first planar member is configured to orthogonally engage with the second planar member. Each of the first and second planar members have a corresponding slot to achieve said orthogonal engagement. Both the first and second planar members each include a plurality of apertures arranged in such a manner to correctly and rigidly hold a plurality of helical radiating elements in a desired position.

An antenna system is disclosed. The antenna system includes the antenna support structure having a plurality of helical radiating elements extending through the antenna support structure. The antenna support structure and the plurality of helical radiating elements are each electrically coupled to a printed circuit.

### TECHNICAL FIELD

This invention relates to an antenna support structure; more particularly, an antenna support structure used as a tuning element for satellite-based communication systems.

### BACKGROUND ART

Circular polarization (CP) signals are commonly used in satellite applications as they propagate in all planes, reducing signal loss and helping to mitigate against anomalies caused by atmospheric conditions, multipath reflections, or fading. To maximize signal power transfer, the receiving and transmitting antennas should be configured to the same CP. Efficiency should be as high as possible and axial ratio (AR) should be below 3.5 dB. Quadrifilar Helix Antenna (QHA) are a good option to use for these requirements. QHA comprise four helical radiating elements (filars) with 90-degree phase shifting for each helical radiating element.

### SUMMARY OF INVENTION

### Technical Problem

An antenna with an AR of less than 3.5 dB is considered a CP antenna. In practice, it is challenging to have AR below 3.5 dB across top hemisphere of the radiation pattern. QHA are used in this situation because of high efficiency and good CP are achievable.

To be able to use QHA in different environments such as boats, cars, planes, etc., the helical radiating elements need to have sufficient support or else breakage of the helical radiating elements from a base printed circuit board may occur. Current solutions are too costly, heavy, and difficult to manufacture and assemble.

### Solution to Problem

An antenna support structure is disclosed. The antenna support structure comprises a first planar member and a second planar member wherein the first planar member is configured to orthogonally engage with the second planar member.

The first planar member comprises a first top end, a first bottom end opposite the first top end, and a first midpoint section extending from the first top end to the first bottom end. The first bottom end comprises one or more first electrical connectors. A first slot extends along the first midpoint section from one of the first top end or the first bottom end. The first planar member further comprises a first half of the first planar member and a second half of the first planar member wherein the first half of the first planar member and the second half of the first planar member are disposed on opposite sides of the first midpoint section. A first plurality of apertures is disposed on each of the first half and the second half of the first planar member.

The second planar member comprises a second top end, a second bottom end opposite the second top end, and a second midpoint section extending from the second top end to the second bottom end. The second bottom end comprises a one or more second electrical connectors. A second slot extends along the second midpoint section from one of the second top end or the second bottom end. The second planar member further comprises a first half of the second planar member and a second half of the second planar member wherein the first half of the second planar member and the second half of the second planar member are disposed on opposite sides of the second midpoint section. A second plurality of apertures is disposed on each of the first half and the second half of the second planar member.

### Advantageous Effects of Invention

The antenna support structure improves mechanical integrity of the antenna system. The helical radiating elements are held in the correct and mechanically strong position.

The antenna support structure can be used to alter and fine tune antenna properties such as efficiency, gain, AR, and radiation pattern. The antenna support structure can fine tune the resonant frequency of the antenna system and can fine tune phase-shifting of electromagnetic waves emitted from the helical radiating elements. Height of the antenna support structure changes AR and gain of the antenna system. Width of the support structure changes efficient, gain, and radiation pattern of the antenna system. AR and back lobe radiation pattern can be adjusted when the antenna support structure is rotated relative to distal ends of the helical radiating elements.

The antenna support structure obtains high performance while maintaining a compact size, lower cost, and ease of assembly.

The antenna support structure can be use in wireless applications such as Iridium, Inmarsat, satellite, GPS, Galileo, and others as can be appreciated by one having skill in the art.

### BRIEF DESCRIPTION OF THE DRAWINGS

Other features, combinations, and embodiments will be appreciated by one having the ordinary level of skill in the art of antennas and accessories upon a thorough review of the following details and descriptions, particularly when reviewed in conjunction with the drawings, wherein:

FIG. 1 shows a perspective view of an antenna support system in accordance with a first illustrated embodiment;

FIG. 2 shows a front plan view of a first planar member of the antenna support system according to the first illustrated embodiment;

FIG. 3 shows a front plan view of a second planar member of the antenna support system according to the first illustrated embodiment;

FIG. 4 shows a top view of the antenna support system according to the first illustrated embodiment;

FIG. 5 shows a perspective view of an antenna system in accordance with a second illustrated embodiment;

FIG. 6 shows a perspective view of an antenna system in accordance with a third illustrated embodiment; and

FIG. 7 shows a perspective view of an antenna system in accordance with a fourth illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “vertically” in regards to “vertically disposed”, “vertically above”, and “vertically below” is in reference to the bottom end of either the first planar member of the second planar member.

The term “equal” in regards to a dimension such as height, length, or width of the means at most a 5% tolerance difference.

The term “coincide” means being positioned within, vertically above, or vertically below a particular region. For example, coinciding within a quadrant means to be positioned within, vertically above, or vertically below said quadrant.

Unless explicitly defined herein, terms are to be construed in accordance with the plain and ordinary meaning as would be appreciated by one having skill in the art.

### General Description of Embodiments

In one embodiment, an antenna support structure is disclosed. The antenna support structure comprises a first planar member and a second planar member. The first planar member comprises a first top end, a first bottom end opposite the first top end, and a first midpoint section extending from the first top end to the first bottom end, the first bottom end comprising one or more first electrical connectors, a first slot extending along the first midpoint section from one of the first top end or the first bottom end, a first half of the first planar member and a second half of the first planar member wherein the first half of the first planar member and the second half of the first planar member are disposed on opposite sides of the first midpoint section, and a first plurality of apertures disposed on each of the first half and the second half of the first planar member. The second planar member comprises a second top end, a second bottom end opposite the second top end, and a second midpoint section extending from the second top end to the second bottom end, the second bottom end comprising one or more second electrical connectors, a second slot extending along the second midpoint section from one of the second top end or the second bottom end, a first half of the second planar member and a second half of the second planar member wherein the first half of the second planar member and the second half of the second planar member are disposed on opposite sides of the second midpoint section, and a second plurality of apertures disposed on each of the first half and the second half of the second planar member. The first planar member is configured to orthogonally engage with the second planar member.

In some embodiments, the first slot may further comprise a first tapered notch and the second slot further comprising a second tapered notch.

In some embodiments, the first slot may extend from the first top end and the second slot extends from the second bottom end.

In some embodiments, the first planar member may further comprise a first width and a first height wherein the first height is greater than the first width. In other embodiments, the first width may be greater than the first height. Additionally, the second planar member comprises a second width and a second height. The second height may be greater than the second width or alternatively the second height is less than the second width.

In some embodiments, the first plurality of apertures may comprise an equal amount to the second plurality of apertures.

In some embodiments, the first plurality of apertures may be vertically disposed such that the first plurality of apertures forms at least a first aperture column and a second aperture column wherein both the first aperture column and the second aperture column are in parallel formation with the first slot. In some embodiments, the first aperture column may be disposed on the first half of the first planar member and the second aperture column is disposed on the second half of the first planar member. In some embodiments, the first column aperture may comprise a colinear alignment.

In some embodiments, the second plurality of apertures may be vertically disposed such that the second plurality of apertures forms at least a third aperture column and a fourth aperture column wherein both the third aperture column and the fourth aperture column are in parallel formation with the second slot. In some embodiments, the third aperture column may be disposed on the first half of the second planar member and the fourth aperture column is disposed on the second half of the second planar member. In some embodiments, the third column aperture may comprise a collinear alignment.

In some embodiments, the first plurality of apertures may be horizontally disposed such that the first plurality of apertures forms at least a first aperture row, a second aperture row, and a third aperture row wherein the first aperture row comprises a parallel alignment with each of the second aperture row and the third aperture row.

In some embodiments, the second plurality of apertures may be horizontally disposed such that the second plurality of apertures forms at least a fourth aperture row, a fifth aperture row, and a sixth aperture row wherein the fourth aperture row comprises a parallel alignment with each of the fifth aperture row and the sixth aperture row.

In some embodiments, the first planar member may further comprise a first height extending from the first top end to the first bottom end, and the second planar member further comprising a second height extending from the second top end to the second bottom end, wherein the first height equals the second height.

In some embodiments, the first slot may further comprise a first slot length, and the second slot further comprising a second slot length, wherein the first height equals the first slot length plus the second slot length.

In some embodiments, the first slot may be engaged with the second slot such the first planar member comprises an orthogonal alignment with the second planar member.

In some embodiments, the first aperture row may be vertically aligned with the fourth aperture row, the second aperture row is vertically aligned with the fifth aperture, and the third aperture row is vertically aligned with the sixth aperture row.

In some embodiments, the first planar member may further comprise a first width extending from the first half of the first planar member to the second half of the first planar member, and the second planar member further comprising a second width extending from the first half of the second planar member to the second half of the second planar member, wherein the first width equals the second width.

In some embodiments, the antenna support structure may further comprise a support center origin extending along an overlap of the first midpoint section and the second midpoint section, wherein the antenna support structure comprises a symmetrical configuration about the support center origin.

In some embodiments, the first slot may further comprise a first slot length, and the second slot further comprising a second slot length, wherein the second slot length is greater than the first slot length.

In one embodiment, an antenna system is disclosed. The antenna system comprises an antenna support structure having and a plurality of helical radiating elements. The antenna support structure comprises a first planar member and a second planar member. The first planar member comprises a first top end, a first bottom end opposite the first top end, and a first midpoint section extending from the first top end to the first bottom end, the first bottom end comprising one or more first electrical connectors, the first planar member further comprising a first slot extending along the first midpoint section from one of the first top end or the first bottom end, a first half of the first planar member and a second half of the first planar member wherein the first half of the first planar member and the second half of the first planar member are disposed on opposite sides of the first midpoint section, and a first plurality of apertures disposed on each of the first half and the second half of the first planar member. The second planar member comprises a second top end, a second bottom end opposite the second top end, and a second midpoint section extending from the second top end to the second bottom end, the second bottom end comprising one or more second electrical connectors, a second slot extending along the second midpoint section from one of the second top end or the second bottom end, the second planar member further comprising a first half of the second planar member and a second half of the second planar member wherein the first half of the second planar member and the second half of the second planar member are disposed on opposite sides of the second midpoint section, and a second plurality of apertures disposed on each of the first half and the second half of the second planar member. The first slot of the first planar member is engaged with the second slot of the second planar member such the first planar member comprises an orthogonal alignment with the second planar member. Each of the plurality of helical radiating elements comprises a proximal end and a distal end, wherein each of the plurality of helical radiating elements extends through at least one of the first plurality of apertures and further wherein each of the plurality of helical radiating elements extends through at least one of the second plurality of apertures.

In some embodiments, the plurality of helical radiating elements may comprise tin.

In some embodiments, the distal end of each of the plurality of helical radiating elements may be disposed vertically above the first top side and the second top side.

In some embodiments, the plurality of helical radiating elements may comprise a total number of radiating elements, such that the first half of the first planar member comprises a number of apertures equal to one less the total number of radiating elements.

In some embodiments, the antenna support structure may further comprise a plurality of quadrants formed by the first planar member and the second planar member.

In some embodiments, each proximal end may coincide in a different quadrant of the plurality of quadrants.

In some embodiments, the distal end of each of the plurality of helical radiating elements may be open-ended.

In some embodiments, the antenna system may further comprise a printed circuit electrically coupled to the proximal end of each of the plurality of helical radiating elements, the one or more first electrical connectors, and the one of more second electrical connectors.

In some embodiments, the antenna system may further comprise an antenna housing base coupled to the printed circuit.

In some embodiments, the antenna system may further comprise an antenna housing cover coupled to the antenna housing base wherein the antenna support structure and the printed circuit are each encapsulated within the antenna housing base and the antenna housing cover.

### Manufacturing

The antenna support structure can be made of material such as FR-4. Otherwise, the antenna support structure can be fabricated in accordance with the level and knowledge of one having skill in the art.

The helical radiating elements can be made of material such as CuSn6 or pure copper. Experiments showed a surprising result that helical radiating elements comprising CuSn6 provided a 10% increase of efficiency over pure Cu. Lower conductivity of CuSn6 compared to pure Cu equates to less skin effect which contributed to the increase in efficiency. Other materials can also be utilized. Other types of materials can also be utilized.

Each of the components of the antenna support structure and related system described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### First Illustrated Embodiment

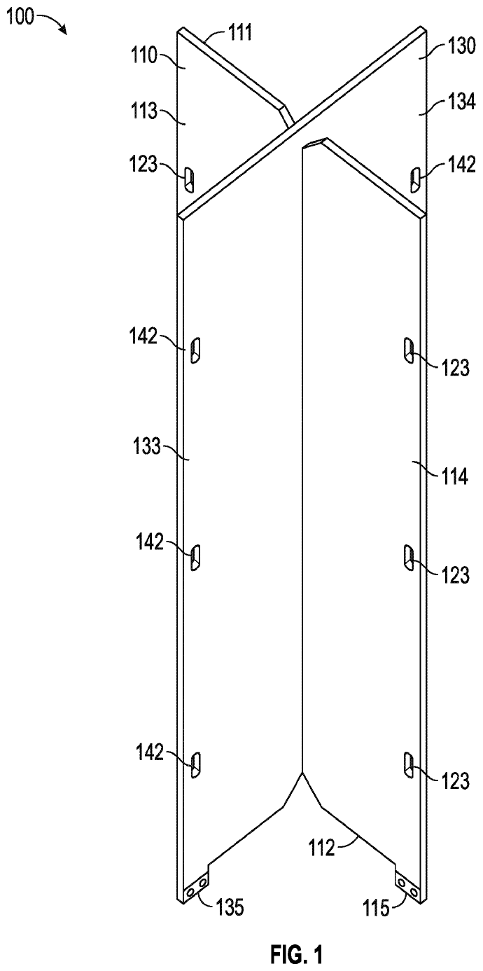

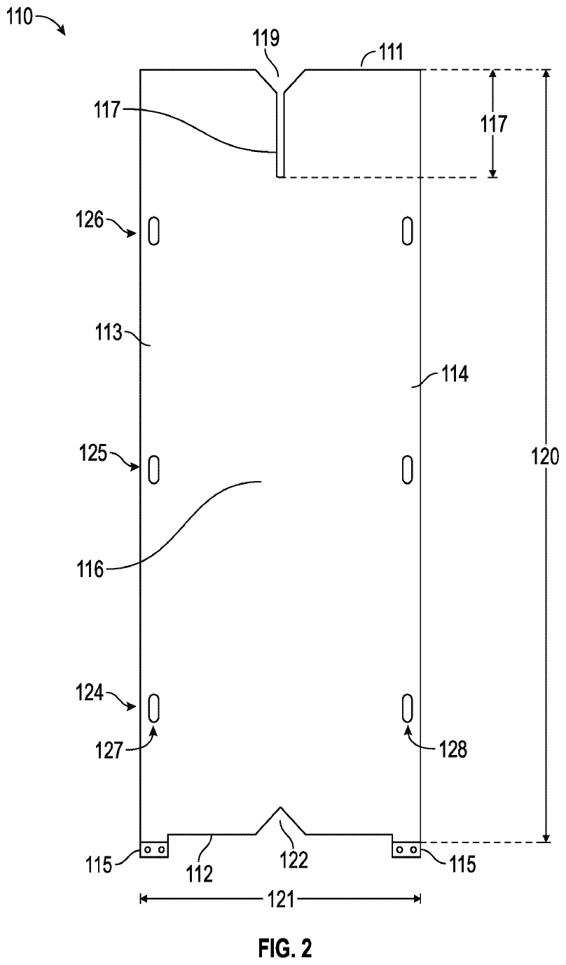

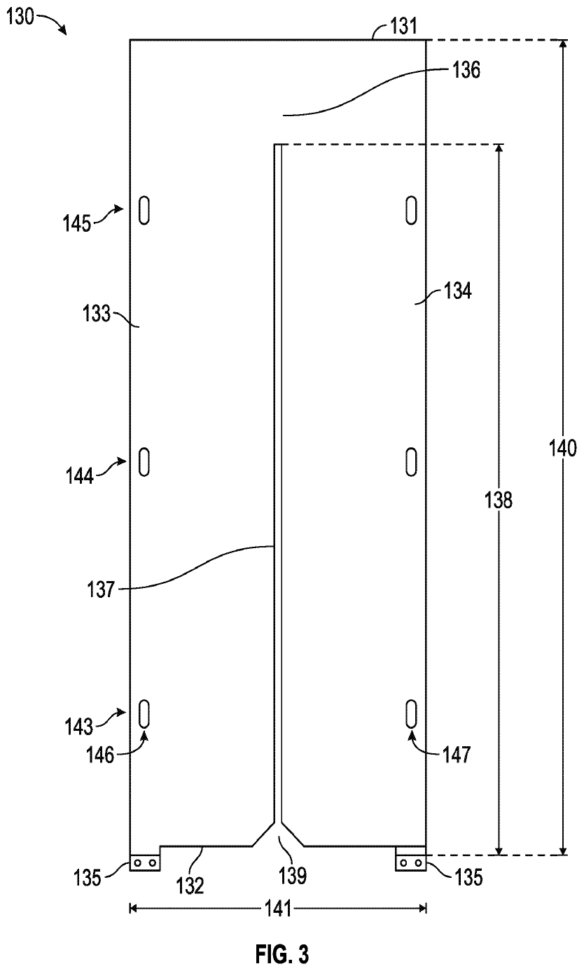

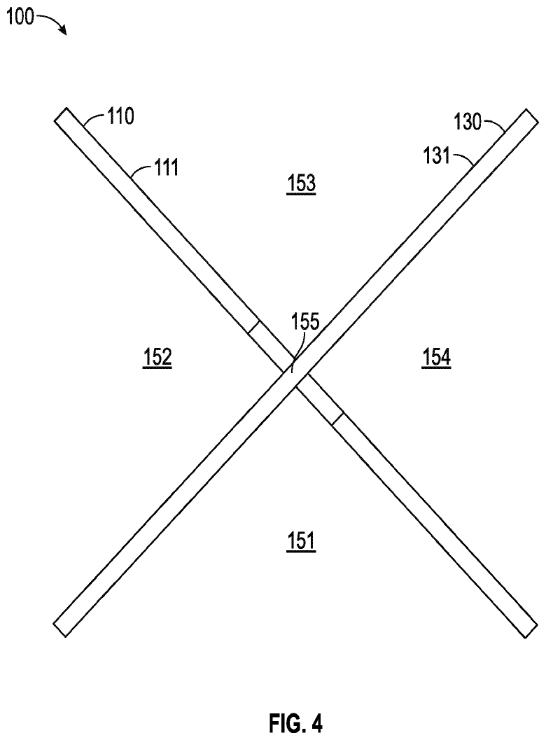

FIG. 1-4 show an antenna support system (100) in accordance with a first illustrated embodiment. The antenna support system comprises a first planar member (110) coupled to a second planar member (130). The first planar member comprises a first top end (111) and a first bottom end (112) opposite the first top end. The first planar member further comprises a first half (113) and a second half (114) wherein both the first half and the second half extend from the first top end towards the first bottom end. The first planar member includes a first height (120) extending between the first top end and the first bottom end, and further includes a first width (121) extending from the first half to the second half. A first midpoint section (116) is disposed between the first half and the second half. A first slot (117) extends from the first top end towards the first bottom end along the first midpoint section. The first slot comprises a first slot length (118) and a first tapered notch (119). The first planar member further comprises a plurality of first electrical connectors (115) disposed at the first bottom end with an auxiliary notch (122) disposed between the first plurality of electrical connectors. The plurality of first electrical connectors may comprise solder tabs. A first plurality of apertures (123) is disposed on both the first half and the second half of the first planar member.

The first plurality of apertures (123) is vertically disposed such that the first plurality of apertures forms at least a first aperture column (127) and a second aperture column (128) wherein both the first aperture column and the second aperture column are in parallel formation with the first slot (117). The first aperture column is disposed on the first half (113) of the first planar member and the second aperture column is disposed on the second half (114). Apertures of the first aperture column comprise a colinear alignment. Likewise, apertures of the second aperture column comprise a colinear alignment.

The first plurality of apertures (123) is horizontally disposed such that the first plurality of apertures forms at least a first aperture row (124), a second aperture row (125), and a third aperture row (126) wherein the first aperture row comprises a parallel alignment with each of the second aperture row and the third aperture row.

The second planar member (130) comprises a second top end (131) and a second bottom end (132) opposite the second top end. The second planar member further comprises a first half (133) and a second half (134) wherein both the first half and the second half extend from the second top end towards the second bottom end. The second planar member includes a second height (140) extending between the second top end and the second bottom end, and further includes a second width (141) extending from the first half to the second half. A second midpoint section (136) is disposed between the first half and the second half. The second planar member further comprises a second slot (137) extending from the second bottom end towards the second top end along the second midpoint section. The second slot comprises a second slot length (138) and a second tapered notch (139). A plurality of second electrical connectors (135) is disposed at the second bottom end. The plurality of second electrical connectors may comprise solder tabs. The second plurality of apertures (142) is disposed on both the first half and the second half of the second planar member.

The second plurality of apertures (142) is vertically disposed such that the second plurality of apertures forms at least a third aperture column (146) and a fourth aperture column (147) wherein both the third aperture column and the fourth aperture column are in parallel formation with the second slot (137). The third aperture column is disposed on the first half (133) of the second planar member and the fourth aperture column is disposed on the second half (134). Apertures of the third aperture column comprise a colinear alignment. Likewise, apertures of the fourth aperture column comprise a colinear alignment.

The second plurality of apertures (142) is horizontally disposed such that the second plurality of apertures forms at least a fourth aperture row (143), a fifth aperture row (144), and a sixth aperture (145) row wherein the fourth aperture row comprises a parallel alignment with each of the fifth aperture row and the sixth aperture row.

The first planar member (110) and the second planar member (113) may comprise a same number of apertures, namely six each with three apertures being disposed on the first half (113; 133) of its respective planar member and three apertures being disposed on the second half (114; 134) of its respective planar member. The number of apertures on each half of a planar member is dependent on a number of helical radiating elements used in conjunction with the antenna support structure (100) and can include four, five, six, or more apertures in some embodiments. The illustrated antenna support structure is designed for use with four helical radiating elements such as filars. The first and second plurality of apertures (123; 142) are apertures for use with helical radiating elements. The first and second planar members may comprise other apertures for other design purposes.

As shown, the first slot length (118) is less than half of the first height (120) and the second slot length (138) is greater than half of the second height (140). In other embodiments, the first slot length equals half of the first height and the second slot length equals half of the second height. In yet other embodiments, the first slot length is greater than half of the first height and the second slot length is less than the second height. One having skill in the art will appreciate the first slot length and the second slot length are complements to each other in order for proper alignment of the first and second plurality of apertures (123; 142). Specifically, the first aperture (124) row is vertically aligned with the fourth aperture row (143), the second aperture row (125) is vertically aligned with the fifth aperture (144), and the third aperture row (126) is vertically aligned with the sixth aperture row (145) when the first planar member (110) is coupled to the second planar member (130).

The first planar member (110) and the second planar member (130) are configured to orthogonally engage with each other through the first slot (117) and the second slot (137). Once engaged, the first planar member and the second planar member are interlocked and prevented from rotating or moving out of an orthogonal alignment due to a thickness of each of the planar members preventing movement from an opposing planar member. The orthogonal alignment forms a plurality of quadrants, namely a first quadrant (151), a second quadrant (152), a third quadrant (153), and a fourth quadrant (154) wherein each of the plurality of quadrants comprises an angle of ninety degrees.

When the first slot (117) is engaged with the second slot (137), the first midpoint section (116) overlaps with the second midpoint section (136). This overlap forms a support center origin (155) extending along said overlap. In some embodiments, the antenna support structure (100) comprises a symmetrical configuration about the support center origin in order to improve results. The symmetrical configuration is achieved by having the first width (121) of the first planar member (110) be equal in length to the second width (141) of the second planar member (130). If outside dimensions of the antenna support structure are symmetrical about the support center origin, better antenna performance will be achieved.

The first height (120) of the first planar member (110) comprises a length that is equal to the second height (140) of the second planar member (130) in order to form a flush configuration between the first top end (111) and the second top end (131).

### Second Illustrated Embodiment

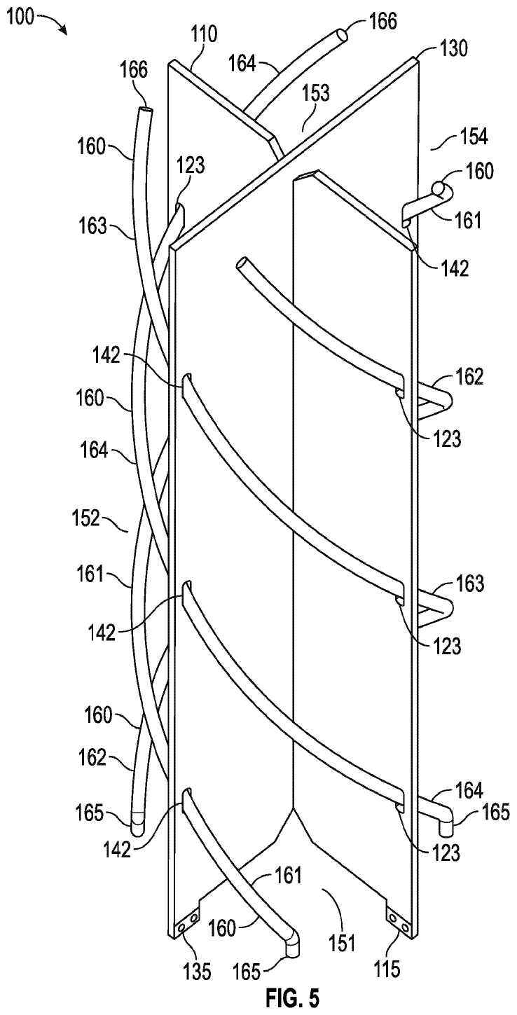

FIG. 5 shows a perspective view of an antenna system in accordance with a second illustrated embodiment. The antenna system comprises an antenna support structure (100) with a plurality of helical radiating elements (160) each having a proximal end (165) and a distal end (166). The plurality of helical radiating elements comprises a first helical radiating element (161), a second helical radiating element (162), a third helical radiating element (163), and a fourth helical radiating element (164). The antenna support structure comprises a first planar member (110) orthogonally coupled to a second planar member (130) wherein the first planar member comprises a first plurality of apertures (123) and the second planar member comprises a second plurality of apertures (142).

Each of the first through fourth helical radiating elements (161; 162; 163; 164) extend through at least one of the first plurality of apertures (123) and at least one of the second plurality of apertures (142). In some embodiments, each of the first through fourth helical radiating elements extend through one of one of the first and second plurality of apertures and two of the other of the first and second plurality of apertures. For example, the proximal end (165) of the first helical radiating element is disposed in a first quadrant (151) of the antenna support structure (100). The first helical radiating element then extends through an initial hole of one of the second plurality of apertures in a clockwise formation. The first helical radiating element then extends through an intermediate hole one of the first plurality of apertures wherein said one of the first plurality of apertures is at a higher elevation than the initial hole. The first helical antenna continues rotating in a helical fashion at a clockwise direction when referenced from a top view of the antenna support structure and extends through a final hole of another of the second plurality of apertures. The final hole comprises a higher elevation than both the intermediate hole and the initial hole. The distal end (166) of the first helical antenna is opened ended and can be vertically above the first and second top ends (111; 131). The other of the plurality of helical radiating element (160) are shown with similar configurations as the first helical radiating element to form a quadrifilar of four filars each having a helical shape around and through the antenna support structure. In other embodiments, the antenna system may comprise more than four filars.

Each of the plurality of helical radiating elements (160) comprises a clockwise rotation of less than 360 degrees. For example, the proximal end (165) of the first helical radiating element (161) coincides with the first quadrant (151) and the distal end (166) of the first helical radiating element convinces with the fourth quadrant (154). In other embodiments, the antenna support structure may comprise additional apertures to allow for additional turning of the helical radiating elements to be greater than 360 degrees.

The plurality of helical radiating elements (160) is positioned such that the proximal end (1650 of each of the plurality helical radiating elements coincides with a different quadrant relative to the other proximal ends. Furthermore, the distal end (166) of each of the plurality of helical radiating elements coincides with a different quadrant relative to the other distal ends.

### Third Illustrated Embodiment

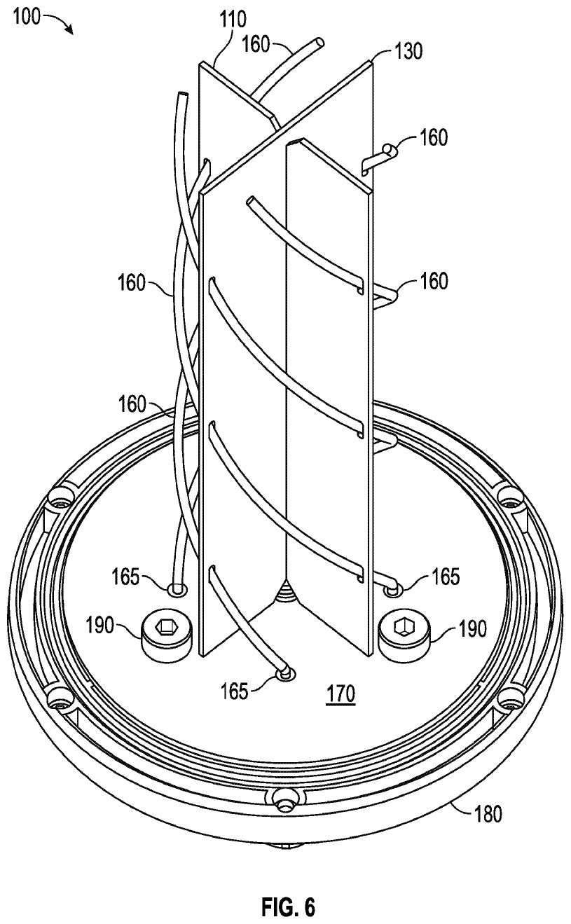

FIG. 6 shows a perspective view of an antenna system in accordance with a third illustrated embodiment. The antenna system comprises an antenna support structure (100) coupled to a printed circuit (170) wherein the antenna support structure is perpendicular to the printed circuit base. The antenna support structure comprises a plurality of helical radiating elements (160) extending through apertures of the antenna support structure in a helical configuration. The coupling of the antenna support structure to the circuit base is achieved in two ways. First is by an electrical connection of plurality of electrical connectors (not shown) disposed at a bottom end thereof. Second is by an electrical connection of a proximal end (165) of each of the plurality of helical radiating elements. The printed circuit is disposed within an antenna housing base (180) and coupled therewith by a plurality of housing apertures (190). The antenna housing base is configured to couple to an antenna housing cover.

### Fourth Illustrated Embodiment

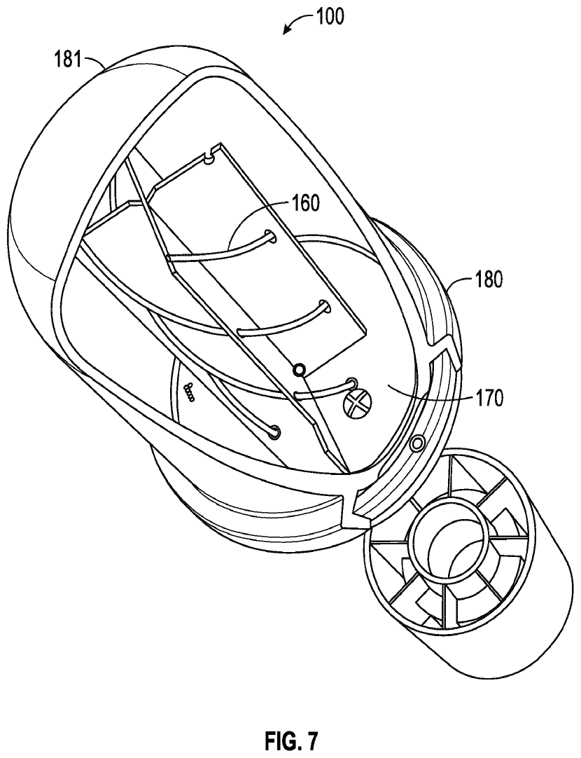

FIG. 7 shows a perspective view of an antenna system in accordance with a fourth illustrated embodiment. The antenna system comprises an antenna support structure (100) coupled to a printed circuit (170). The antenna support structure comprises a plurality of helical radiating elements (160) extending through apertures of the antenna support structure. The antenna support structure, the plurality of helical radiating elements, and the printed circuit are encapsulated in a housing comprising an antenna housing cover (181) and an antenna housing base (180). As shown, the antenna housing cover includes a missing section in order to illustrates the antenna support structure disposed therein. One having skill in the art will appreciate that a final design will have the antenna support structure fully encapsulated.

### FEATURE LIST

antenna support structure (100)
first planar member (110)
first top end (111)
first bottom end (112)
first half of the first planar member (113)
second half of the first planar member (114)
first electrical connector (115)
first midpoint section (116)
first slot (117)
first slot length (118)
first tapered notch (119)
first height (120)
first width (121)
auxiliary notch (122)
first plurality of apertures (123)
first aperture row (124)
second aperture row (125)
third aperture row (126)
first aperture column (127)
second aperture column (128)
second planar member (130)
second top end (131)
second bottom end (132)
first half of the second planar member (133)
second half of the second planar member (134)
second electrical connector (135)
second midpoint section (136)
second slot (137)
second slot length (138)
second tapered notch (139)
second height (140)
second width (141)
second plurality of apertures (142)
fourth aperture row (143)
fifth aperture row (144)
six aperture row (145)
third aperture column (146)
fourth aperture column (147)
first quadrant (151)
second quadrant (152)
third quadrant (153)
fourth quadrant (154)
support structure center (155)
plurality of helical radiating elements (160)
first helical radiating element (161)
second helical radiating element (162)
third helical radiating element (163)
fourth helical radiating element (164)
proximal end (165)
distal end (166)
printed circuit (170)
antenna housing base (180)
antenna housing cover (181)
plurality of housing fastener (190)

What is claimed is:

1. An antenna support structure comprising:
a first planar member, the first planar member comprising:
a first top end, a first bottom end opposite the first top end, and a first midpoint section extending from the first top end to the first bottom end, the first bottom end comprising one or more first electrical connectors,
a first slot extending along the first midpoint section from one of the first top end or the first bottom end,
a first half of the first planar member and a second half of the first planar member wherein the first half of the first planar member and the second half of the first planar member are disposed on opposite sides of the first midpoint section, and
a first plurality of apertures disposed on each of the first half and the second half of the first planar member; and
a second planar member, the second planar member comprising:
a second top end, a second bottom end opposite the second top end, and a second midpoint section extending from the second top end to the second bottom end, the second bottom end comprising one or more second electrical connectors,
a second slot extending along the second midpoint section from one of the second top end or the second bottom end,
a first half of the second planar member and a second half of the second planar member wherein the first half of the second planar member and the second half of the second planar member are disposed on opposite sides of the second midpoint section, and
a second plurality of apertures disposed on each of the first half and the second half of the second planar member;
wherein the first planar member is configured to orthogonally engage with the second planar member.

2. The antenna support structure of claim 1, wherein the first slot extends from the first top end and the second slot extends from the second bottom end.

3. The antenna support structure of claim 1, wherein the first plurality of apertures is vertically disposed such that the first plurality of apertures forms at least a first aperture column and a second aperture column wherein both the first aperture column and the second aperture column are in parallel formation with the first slot.

4. The antenna support structure of claim 3, wherein the first aperture column is disposed on the first half of the first planar member and the second aperture column is disposed on the second half of the first planar member.

5. The antenna support structure of claim 3, wherein the first column aperture comprises a colinear alignment.

6. The antenna support structure of claim 3, wherein the second plurality of apertures is vertically disposed such that the second plurality of apertures forms at least a third aperture column and a fourth aperture column wherein both the third aperture column and the fourth aperture column are in parallel formation with the second slot.

7. The antenna support structure of claim 6, wherein the third aperture column is disposed on the first half of the second planar member and the fourth aperture column is disposed on the second half of the second planar member.

8. The antenna support structure of claim 6, wherein the third column aperture comprises a collinear alignment.

9. The antenna support structure of claim 1, wherein the first plurality of apertures is horizontally disposed such that the first plurality of apertures forms at least a first aperture row, a second aperture row, and a third aperture row wherein the first aperture row comprises a parallel alignment with each of the second aperture row and the third aperture row.

10. The antenna support structure of claim 9, wherein the second plurality of apertures is horizontally disposed such that the second plurality of apertures forms at least a fourth aperture row, a fifth aperture row, and a sixth aperture row wherein the fourth aperture row comprises a parallel alignment with each of the fifth aperture row and the sixth aperture row.

11. The antenna support structure of claim 1, wherein the first slot is engaged with the second slot such the first planar member comprises an orthogonal alignment with the second planar member.

12. The antenna support structure of claim 11, wherein the first aperture row is vertically aligned with the fourth aperture row, the second aperture row is vertically aligned with the fifth aperture, and the third aperture row is vertically aligned with the sixth aperture row.

13. The antenna support structure of claim 11, the first planar member further comprising a first width extending from the first half of the first planar member to the second half of the first planar member, and the second planar member further comprising a second width extending from the first half of the second planar member to the second half of the second planar member, wherein the first width equals the second width.

14. An antenna system, comprising
an antenna support structure, the antenna support structure comprising:
a first planar member, the first planar member comprising a first top end, a first bottom end opposite the first top end, and a first midpoint section extending from the first top end to the first bottom end, the first bottom end comprising one or more first electrical connectors, the first planar member further comprising a first slot extending along the first midpoint section from one of the first top end or the first bottom end, a first half of the first planar member and a second half of the first planar member wherein the first half of the first planar member and the second half of the first planar member are disposed on opposite sides of the first midpoint section, and a first plurality of apertures disposed on each of the first half and the second half of the first planar member, and
a second planar member, the second planar member comprising a second top end, a second bottom end opposite the second top end, and a second midpoint section extending from the second top end to the second bottom end, the second bottom end comprising one or more second electrical connectors, a second slot extending along the second midpoint section from one of the second top end or the second bottom end, the second planar member further comprising a first half of the second planar member and a second half of the second planar member wherein the first half of the second planar member and the second half of the second planar member are disposed on opposite sides of the second midpoint section, and a second plurality of apertures disposed on each of the first half and the second half of the second planar member;
wherein the first slot is engaged with the second slot such the first planar member comprises an orthogonal alignment with the second planar member; and
a plurality of helical radiating elements, each of the plurality of helical radiating elements comprising a proximal end and a distal end, wherein each of the plurality of helical radiating elements extends through at least one of the first plurality of apertures and further wherein each of the plurality of helical radiating elements extends through at least one of the second plurality of apertures.

15. The antenna system of claim 14, the antenna support structure further comprising a plurality of quadrants formed by the first planar member and the second planar member.

16. The antenna system of claim 15, wherein each proximal end coincides in a different quadrant of the plurality of quadrants.

17. The antenna system of claim 14, wherein the distal end of each of the plurality of helical radiating elements is open-ended.

18. The antenna system of claim 14, further comprising a printed circuit electrically coupled to the proximal end of each of the plurality of helical radiating elements, the one or more first electrical connectors, and the one or more second electrical connectors.

19. The antenna system of claim 18, further comprising an antenna housing base coupled to the printed circuit.

20. The antenna system of claim 19, further comprising an antenna housing cover coupled to the antenna housing base wherein the antenna support structure and the printed circuit are each encapsulated within the antenna housing base and the antenna housing cover.
